(19) United States
(12) Patent Application Publication
(10) Pub. No.: US 2001/0006728 A1
(43) Pub. Date: Jul. 5, 2001

(54) Dipped cord made of melt spun filament yarns of an alternating copolymer and a process for manufacturing said cord

(75) Inventors: Johannes Anthonij Juijn, Velp (NL); Marcelinus Herman Jozef Hottenhuis, Loo (NL); Berend Johan Tabor, Zevenaar (NL)

Correspondence Address: OLIFF & BERRIDGE, PLC, P.O. BOX 19928, ALEXANDRIA, VA, 22320, US

(73) Assignee: Acordis Industrial Fibers B.V.

(21) Appl. No.: 09/740,056

(22) Filed: Dec. 20, 2000

(30) Foreign Application Priority Data
Dec. 20, 1999 (EP) 99 204 413.1

(51) Int. Cl. D02G 3/48; D01D 5/08; B05D 1/18

(52) U.S. Cl. 428/374; 264/129; 428/394; 427/434.6

(57) ABSTRACT

Dipped cords made from melt-spun filament yarns of an alternating copolymer of alkenes and carbon monoxide have a cord twist factor in the range of 120 to 250 and a breaking tenacity BT≧750 mN/tex, a TASE-2>70 mN/tex, and a HAS-2′-180° C. (5 mN/tex)<3.6%. These dipped cords are made by subjecting drawn filament yarns to a dipping treatment. Preference is given to dipped cords having a breaking tenacity BT≧850 mN/tex and a TASE-2>75 mN/tex, which are obtainable from yarns wherein after dipsimulation, the aspect ratio of the crystals 2Λ₀₀₂/(Λ₂₁₀+Λ₃₁₀) varies between 2.3 and 2.7. The cords are preeminently suitable to reinforce rubber articles such as car tires.

### BACKGROUND OF THE INVENTION

1. Field of the Invention

The invention pertains to dipped cord made of melt spun filament yarns of a copolymer of alkenes and carbon monoxide, to a process for manufacturing said cord by subjecting drawn filament yarns to a dipping treatment, and to rubber articles such as tires incorporating such cord.

2. Discussion of Related Art

The manufacture of cord from melt spun filament yarns of the aforesaid type is disclosed in Example 2 of EP-A-0 310 171. In this example, use is made of yarns obtained from as-spun yarn stretched five- to tenfold. There is no mention at all of the tensions applied during the stretching process. What is mentioned is a spinning temperature range of from 515 K to 560 K (268-293° C.), which shows that the polymer was seriously affected by thermal degradation. This may give rise to problems such as discoloration of the polymer, an unstable spinning performance, a risk of yarn rupture, a wide variation in the properties of the formed fibers, and a marked deterioration of their mechanical properties. It is clear that the properties of cords made of such yarns will also be unsatisfactory. For instance, it was found that these cords exhibit much higher shrinkage than cords made of fibers of polyethylene terephthalate (PET). Not surprisingly, the latter cords are used on a very large scale in tires.

### SUMMARY OF THE INVENTION

The present invention provides dipped cord made of drawn filament yarns of a copolymer of alkenes and carbon monoxide and having a cord twist factor TF from 120 to 250 which differs from known dipped cords of similar composition through a high breaking tenacity, a high modulus (TASE-2), and a low shrinkage (HAS-2′-180° C. (5 mN/tex)).

The alternating copolymer composed of alkenes and carbon monoxide of which the melt-spun yarns are made generally has an intrinsic viscosity in m-cresol at 25° C. of at least 0.3 dl/g.

The yarns used for manufacturing the dipped cords according to the invention are melt-spun from an alternating copolymer composed of ethylene/propylene and carbon monoxide with a propylene content between 8 and 0.5 mole %, preferably between 4 and 0.5 mole %, calculated on ethylene.

### DETAILED DESCRIPTION OF PREFERRED EMBODIMENTS

The dipped cord according to the invention is characterized by a

breaking tenacity BT≧750 mN/tex,

TASE-2>70 mN/tex, and

HAS-2′-180° C. (5 mN/tex)<3.6%.

The cord twist factor TF is a function of the cord twist, the cord linear density, and the yarn density, and can be represented by means of the formula:

$$TF = \frac{CT}{\sqrt{LD / D}} ,$$

wherein CT stands for the cord twist in number of twists per meter, LD is the linear density of the cord in tex, and D represents the density of the material in kg/m³.

Preferably, the dipped cord has the following properties:

breaking tenacity BT≧800 mN/tex,

TASE-2>75 mN/tex, and

HAS-2′-180° C. (5 mN/tex)≦3%.

Such cord is obtainable from yarns which after dipsimulation have the following structural properties:

crystal density D_{c}>1,285 kg/m³,

birefringence Dn>0.0570, and

crystallinity V_{c}>40%, with an

aspect ratio of the crystals 2Λ₀₀₂/(Λ₂₁₀+Λ₃₁₀) between 2 and 3.

TASE-2 in this case stands for TASE 2% (in mN/tex) of the cord in accordance with ASTM D885-98, which is calculated from the FASE 2 value with the aid of the formula:

TASE 2%=FASE 2(N)/linear density (dtex)×10⁴,

with the linear density also being determined in accordance with ASTM D885-98 (standard method, conditioned with 5 mN/tex pre-tension) and furthermore being corrected for dip pick up (DPU). The dip pick up was determined by measuring the difference in linear density between dipped and undipped cords, with the same tension and temperature being applied for undipped cords as for dipped cords.

HAS-2′-180° C. (5 mN/tex) stands for the shrinkage after 2 minutes at 180° C. under a tension of 5 mN/tex.

The aspect ratio of the crystals 2Λ₀₀₂/(Λ₂₁₀+Λ₃₁₀) can be calculated from the widths Hₕₖₗ of their respective XRD peaks.

A dipped cord according to the invention with optimum properties has a

breaking tenacity BT≧850 mN/tex, and

TASE-2>75 mN/tex.

Such dipped cord is obtainable from yarns wherein after dipsimulation the aspect ratio of the crystals 2Λ₀₀₂/(Λ₂₁₀+Λ₃₁₀) varies between 2.3 and 2.7.

The invention further pertains to a process for manufacturing a dipped cord, according to which filament yarns made of a thermoplastic copolymer of alkenes and carbon monoxide having a

breaking tenacity BT≧900 mN/tex,

melting point Tₘ>220° C.,

crystallinity V_{c}>33%, and

birefringence Δn>0.0550

are processed using a technique known in the art to form a cord, which cord is successively dipped in an aqueous solution of resorcinol-formaldehyde-latex (RFL), dried, and subjected to a thermal treatment at a temperature in the range of 210 to 250° C. under a tension of from 20 to 120 mN/tex.

Preference is given in this case wherein in the above process use is made of melt-spun yarns having a

breaking tenacity BT≧950 mN/tex,

crystal density D_{c}>1,285 kg/m³,

crystallinity V_{c}>40%, and

birefringence Δn>0.0570.

Filament yarns having the aforesaid properties can be obtained by means of the process described in non-prepublished patent application PCT/EP 99/05475, incorporated herein by reference. It discloses the spinning process being performed using a polymer melt free of crystallization nuclei at a temperature of at most 40 K above the melting temperature of the polymer Tₘ (in K) and the yarn being drawn at a temperature in the range of T_{mc}-15 K to T_{mc}-90 K, with T_{mc} representing the “constrained” melting temperature, at a draw ratio of from 5 to 12 and a drawing tension corrected for temperature DT_{d,corr.} in the range of 105 to 300 mN/tex, with

$${DT}_{d , corr .} = \frac{{F}_{DR} \cdot DR}{{tex [ {ⅇ}^{( 1000 / {T}_{d} )} - {ⅇ}^{( 1000 / {T}_{mc} )} ]}^{0.8}} , wherein$$

F_{DR} represents the force measured at a draw ratio DR (in mN) and T_{d} represents drawing temperature (in K), use being made in the calculation of the corrected drawing tension of the linear density of the yarn prior to the start of the drawing process.

Surprisingly, it has been found that when the right combination of drawing temperature and drawing tension is applied, the yarns obtained are not only of exceptionally high and constant quality, but also pre-eminently suitable to be made into a cord which exhibits low shrinkage after dipping and curing.

In this way, filament yarns having a

breaking tenacity BT≧950 mN/tex,

crystal density>1,285 kg/m³,

crystallinity V_{c}>40%, and

birefringence Δn>0.0570,

can be obtained when in the spinning process described in PCT/EP 99/05475 use is made of a polymer melt free of crystallization nuclei and the drawing of the fibers is carried out at a temperature in the range of T_{mc}-10 K to T_{mc}-50 K, at a draw ratio of from 7 to 12 and a drawing tension corrected for temperature DT_{d,corr.} in the range of 140 to 290 mN/tex.

The alternating copolymer of alkenes and carbon monoxide of which the melt spun filament yarns to be used in the manufacture of the dipped cords according to the invention are made up generally has an intrinsic viscosity in m-cresol at 25° C. of at least 0.3 dl/g, but preferably in the range of 0.5 to 5 dl/g, with an intrinsic viscosity of 1.2-4.5 dl/g, more particularly of 1.2-2.5 dl/g, being preferred.

The melt spun filament yarns made thereof which are suitable for manufacturing a cord according to the invention will generally have a breaking tenacity (BT)≧950 mN/tex, preferably ≧1,000 mN/tex.

Such a high breaking tenacity may be attained when in drawing these yarns, use is made of a draw ratio of at least 7 at a drawing tension corrected for temperature DT_{d,corr.} of more than 140 mN/tex.

By alternating copolymers of alkenes and carbon monoxide are meant, according to the invention, polymers built up from alkene and carbon monoxide units in alternating sequence. This means that in the polymer chain, each carbon monoxide unit will have two alkene units as its immediate neighbors, and vice versa.

In the process according to the invention, in the manufacture of filament yarns having properties which render these yarns pre-eminently suitable for the manufacture of cord of high breaking tenacity and low shrinkage, preferably use is made of a polymer where 80-100% of the alkene units are composed of ethylene and 20-0% are composed of propylene. The preparation of alternating copolymers made of alkenes and carbon monoxide is described, int. al., in EP-A-121 965, EP-A-222 454, EP-A-224 304, EP-A-227 135, EP-A-228 733, EP-A-229 408, EP-A-235 865, EP-A-235 866, EP-A-239 145, EP-A-245 893, EP-A-246 674, EP-A-246 683, EP-A-248 483, EP-A-253 416, EP-A-254 343, EP-A-257 663, EP-A-259 914, EP-A-262 745, EP-A-263 564, EP-A-264 159, EP-A-272 728, and EP-A-277 695.

In order to improve the polymer's resistance to thermal degradation, adjuvants counteracting said degradation can be added to the polymer. Examples of such adjuvants are inorganic acid binding compounds such as calcium hydroxyapatite or alumina, polymer stabilizers such as sterically hindered phenols, carbodiimides, epoxy compounds, and phosphites, or combinations thereof.

In melt spinning alternating copolymers made up of alkenes and carbon monoxide, use may be made of equipment also known to be used for melt-spinning other thermoplastic polymers. For instance, in the extrusion of the polymer, use may be made of a spinneret plate such as is employed in melt-spinning other polymers such as polyethylene terephthalate. Such a spinneret plate has a number of capillaries having a diameter of 200 to 2000 μm and an L/D ratio of 1 to 10.

Highly advantageous results are obtained when the spinneret plate is connected up with a heated tube the temperature of which at most equals the spinning temperature (Tₛₚᵢₙ). Preferably, a heated tube with a temperature between Tₛₚᵢₙ-50° C. and Tₛₚᵢₙ is employed.

After spinning, the resulting yarns can be wound prior to being drawn. Alternatively, if so desired, the yarns can be drawn immediately following on from the spinning process.

The resulting yarns are pre-eminently suitable for use in the manufacture of cords for use in tires on account of the favorable combination of high breaking tenacity, low shrinkage, and adhesion to rubber. Also, the cords are highly suitable for reinforcing other rubber articles such as conveyor belts and vee belts.

Measuring methods

Intrinsic viscosity [η]

[η] is determined by the equation:

[η]=lim_{c→0} η_{spec}/c=lim_{c→0}(t−t₀)/t₀.c

and so represents the ratio between the flow times t and t₀, with t₀ being the flow time of the solvent and t being the flow time of the solution containing the polymer in a capillary viscometer at 298 K (25° C.). In this equation, c stands for the polymer concentration in m-cresol, expressed in grams per deciliter.

In order to characterize the structure of the melt spun yarns according to the invention, a two-phase model was adopted in which separate crystalline and amorphous domains can be discerned. Structural characterization was carried out by combining the results of X-ray diffraction, density measurements, birefringence, and differential scanning calorimetry.

X-ray diffraction (XRD)

WAXS measurements were carried out in transmission on samples prepared by winding a smooth layer of yarn filaments around a metal frame. The vertical diffractometer (Philips) was equipped with a quartz monochromator, Soller slits, a divergence slit (1°), a scatter slit (0.2 mm), a receiving slit (1°) and a sealed gas filled detector PW1711/10. The X-ray source was a CuKα tube with λ=1.5418 Å. The diffractometer was coupled to a computer for collecting the data. The X-ray scans were fitted by means of Pearson VII functions.

Density

The density of the samples was determined at 23° C. in a Davenport gradient column containing toluene and tetrachloromethane mixed in a gradually decreasing ratio. The density measurements were carried out on three pieces of yarn. After 12 hours the density was calculated from their positions in the column.

Birefringence

Twenty filaments, immersed in dibutyl phthalate, were positioned parallel to each other between microscopic glasses and placed at an angle of 45° to the crossed polarizers of an optical microscope, which was equipped with a sodium lamp (λ=0.5893 μm) and a Sénarmont compensator. At the ends of the filaments, which were cut on the bias, the overall phase difference φ was determined by measuring the number of fringes (including partial fringes). For each filament, the birefringence was calculated from Δn=(φ/2π)*(λ/D), with D representing the diameter of the filament.

Melting point Tₘ

The crystalline melting point Tₘ was determined with Differential Scanning Calorimetry (DSC).

The melting peaks of the yarn were determined with a Perkin-Elmer DSC-7 by heating the sample (3-4 mg) in a cup at a rate of 20° C./min and recording the heat flow difference between the sample cup and an empty reference cup.

T_{mc}, the “constrained” melting temperature, was determined in a manner analogous to the Tₘ determination using Differential Scanning Calorimetry, with the proviso that instead of a yarn sample that can move freely, a yarn tightly wound around a metal strip was employed.

T_{NF}, the temperature at which the polymer is free of crystallization nuclei (T_{NF}), was determined as follows:

3-4 mg of polymer were introduced into 10 μl aluminum cups provided with lids with perforations. These cups were put into a Perkin Elmer DSC-7 Robotic system and subjected to the following temperature program:

heating from Tᵣₒₒₘ to T_{hold} at a heating-up rate of 10° C./min, with T_{hold}≧Tₘ (the crystalline melting point of the polymer),

keeping at a constant temperature of T_{hold} for t minutes, and

cooling down to room temperature at a cooling rate of 10° C. /min, with T_{hold} being varied in the range of Tₘ to Tₘ+50 and with time t preferably being 1-3 minutes of keeping at a constant temperature.

The cooling curve enables the determination of both the peak temperature of the recrystallization (T_{rc}) and the onset of the recrystallization (T_{rco}).

The value of T_{rc} or T_{rco} measured over one and the same period of keeping at a constant temperature is then plotted against T_{hold}. On the axis on which T_{hold} is plotted T_{NF} can be read from the point of inflection in the curve found.

The aspect ratio of the crystal sizes, was obtained from XRD measurements.

Because of its polymorphic nature the copolymer, hereinafter PK, can crystallize into two possible conformations, called PK-α and PK-β. Although PK-β is the more likely structure, both possibilities were taken into consideration.

The total amount of crystalline volume, V_{c}, was calculated as

$${V}_{c} = \frac{D - {D}_{a}}{{D}_{c} - {D}_{a}}$$

in which D is the (measured) overall density, Dₐ represents the amorphous density (for which a value of 1,221 kg/m³ was taken), and D_{c} is the total crystalline density, defined as:

D_{c}=V_{α}*D_{c,}_{^{α}}+(1−V_{α})*D_{c,}_{^{β}}.

In this formula, V_{α}represents the (volume) percentage of crystalline material that is in the α-structure. This factor is determined directly from the quotient of areas of the respective (210) peaks in the XRD equator scan (after fitting), according to:

$${V}_{α} = \frac{{A}_{α ( 210 )}}{{A}_{α ( 210 )} + {A}_{β ( 210 )}}$$

D_{c,}_{^{α}}and D_{c,}_{^{β}}are the respective crystalline densities of the α and β-structures. They can be calculated directly from the molar mass and the dimensions of the unit cell in the orthorhombic structure. These unit cell parameters \vec{a}, \vec{b}, and \vec{c}are determined from the positions of the XRD (hkl) peaks after fitting, according to the following Table 1:

TABLE 1

| | a axis | b axis | c axis |
|---|---|---|---|
| α-structure | (200) | (210) and (200) | (002) |
| β-structure | (210) and (310) | (210) and (310) | (002) |

As a measure of the average crystallite size, S_{c}, the product of one-dimensional crystal sizes in three crystallographically independent directions was calculated according to:

α-structure: S_{c,}_{^{α}}=Λ₂₀₀*Λ₂₁₀*Λ₀₀₂

β-structure: S_{c,}_{^{β}}=Λ₂₁₀*Λ₃₁₀*Λ₀₀₂

in which the crystal dimension parameters Λₕₖₗ are calculated from the widths Hₕₖₗ of their respective XRD peaks (after fitting and correcting them for instrumental line broadening) according to:

$${Λ}_{hkl} = \frac{λ * 180}{π \sqrt{( {H}_{hkl}^{2} - 0.01 )} * cos {θ}_{hkl}}$$

The height of the crystals (α or β) is the above-mentioned Λ₀₀₂.

Test methods

The tensile properties such as breaking force, elongation at break, modulus as FASE, and properties derived therefrom like breaking tenacity and TASE were measured in accordance with ASTM D885-98, with the exception of the standard atmosphere for testing textiles. The clamps used were of a bollard type, Instron Type 2714-006 (formerly 4D). The space between the clamps was set to a nominal gauge length of 500 mm. Prior to testing, a twist of 60 tpm was inserted into the zero twisted yarns. The pretension in the slack start procedure was 5 mN/tex and the rate of extension was 500 mm/min.

Breaking tenacity of the yarn:

The breaking tenacity (BT) of the yarn as defined in ASTM D885-98, published in January 1998, was calculated from the breaking force and the measured filament tex. To determine the breaking force curve, a multifilament yarn is elongated to rupture on an Instron tensile tester. The length between the grips is 10 cm. The results for 3 yarns are averaged. All samples were elongated at a constant rate of elongation of 10 mm/min.

The breaking tenacity is expressed in mN/tex and was measured on fibers which had been conditioned for at least 16 hours of conditioning in a standard atmosphere in accordance with ISO 139.

Breaking tenacity of the cord:

The cord properties were measured after a minimum of 16 hours of conditioning in a standard atmosphere in accordance with ISO 139.

The breaking tenacity (BT in mN/tex) and TASE 2% (in mN/tex) of the cord were determined in accordance with ASTM D885-98 (Tire cords, tire cord fabrics, and industrial filament yarns made from man-made organic base fibers), with TASE 2% being calculated from the FASE 2 value according to the formula:

TASE 2%=(FASE 2(N)/linear density (dtex))×10⁴,

with the linear density also being determined in accordance with ASTM D885-98 (conditioned) and furthermore being corrected for dip pick up (DPU). The dip pick up was determined by measuring the difference in linear density between dipped and undipped cords, with the same tension and temperature being applied for undipped cords as for dipped cords.

The shrinkage (HAS in %) of the cord was determined in accordance with ASTM D4974-93 (Thermal shrinkage of yarn and cord using the testrite thermal shrinkage oven).

The invention will be elucidated with reference to the examples below. Of course, the examples are intended for illustrative purposes only and do not necessarily limit the scope of the invention.

### EXAMPLE 1

An alternating copolymer of ethylene/propylene and carbon monoxide with a propylene content of 7 mole % calculated on ethylene, a melting point of 225° C. (measured with DSC), and an intrinsic viscosity [η] of 1.53 was spun in three runs, with slight differences in the spinning conditions.

The polymer was melted in an extruder with five heating zones. The throughput was 92 g/min, giving a residence time in the extruder of 114 sec. The melt was passed on via a polymer line and a spinning pump to a spinpack with a spinneret plate. The residence time in this section was 43 sec, thus making for a total of 157 sec.

The spinneret plate had 36 spinning holes each with a diameter of 400 μm. Underneath the spinneret plate, an electrically heated tube was accommodated which retarded the cooling of the spinning bundle. This was followed by a cooling zone of 80 cm, with cross-flow cooling air of 20° C., supplied with an air pressure over the sieve package of the blowbox of 125 N/m².

Further data on temperatures, machine geometry, and as-spun yarn count for the three runs can be found as Examples 1a, 1b, and 1c in Table 2.

### EXAMPLE 2

An alternating copolymer of ethylene/propylene and carbon monoxide with a propylene content of 3 mole % calculated on ethylene, a melting point of 239° C. (measured with DSC), and an intrinsic viscosity [η] of 1.53 was spun in accordance with the machine settings indicated in Example 1. Polymer throughput, residence times, spinning hole number and diameter, cooling conditions, and spinning speed were as described in Example 1. The temperatures were adjusted to the higher melting point of the polymer. The data is shown in Table 2.

### EXAMPLE 3

The as-spun yarns described as Examples 1a, 1b, 1c, and 2 were drawn in supersaturated steam, in a steambox of 2 m in length. The initial speed was 6 m/min. The draw ratios and steam temperatures are shown in Table 3. The example numbers used are: 3-1a, 3-1b, 3-1c, and 3-2, respectively.

The drawing forces F_{dr}, in mN, were measured and are included in Table 3. From the drawing force F_{dr}, the draw ratio DR, and the count of the as-spun yarn the drawing tension DT_{d} was calculated, with the formula DT_{d}=F_{dr}.DR/tex. DT_{d} was then corrected for the applied drawing temperature according to the formula shown earlier, giving the corrected drawing tension DT_{d,corr}. The constrained melting temperature, measured via DSC, was 240° C. for the low-melting polymer and 255° C. for the high-melting polymer used in the examples.

High values for DT_{d,coor} correspond with high values for the breaking tenacity BT, which values are also included in Table 3. Finally, the figures for crystallinity (V_{c}) and orientation (birefringence, Δn) are shown in Table 3.

### EXAMPLE 4

As-spun yarn 2 was drawn in three steps, again in supersaturated steam, with increasing draw ratio and steam temperature in the consecutive steps. Two machine adjustments with slight differences were used. The data for these examples is presented as numbers 4-2a and 4-2b in Table 3.

The first step took place in one or two adjacent boxes of 2 m in length, the following steps contained one box of 2 m in length. The data for DT_{d} and DT_{d,corr} was calculated for the last step only, making use of a constrained melting point of 255° C., measured via DSC. The drawing tension DT_{d} is low, but the high drawing temperature results in a high value for DT_{d,corr}, corresponding to a high tenacity of the resulting yarn. The values for Vc and Δn are also shown in Table 3.

### EXAMPLE 5

The drawn yarns of Examples 3-1c, 3-2, and 4-2b were treated under conditions simulating the dipping conditions for tire cord. The simulation was carried out on a computreater of Litzler. Four drawn yarns with 36 filaments were assembled and twisted to an f 144Z30 yarn on a Lezzeni BRH, representing a typical single yarn used in tire cord production. The yarn was twisted and water was used instead of the dip solution. This dip simulation enables easy analysis of the properties and the physical structure of the treated yarns.

Cord dipping is usually carried out in three steps: drying, stretching, and relaxation. The dip simulation of the yarns was performed accordingly. The first step (drying) was carried out under standard conditions: 150° C., 120 sec residence time in the oven, and 20 mN/tex yarn tension. The second step (stretching) was carried out at varying temperature, a tension of 70 or 100 mN/tex, and a residence time in the oven of 30 sec. The third step (relaxation) was carried out at varying temperature, a tension of 12.5 mN/tex, and a residence time in the oven of 30 sec.

The varied process parameters are shown in Table 4.

The breaking tenacity, elongation at break, modulus (TASE-2), and shrinkage (HAS-2′-180° C.) were measured before and after the dip simulation treatment. The results are shown in Table 4. The breaking tenacity and modulus of the treated yarns are also given as a percentage of the values for the untreated yarn.

Table 4 further shows the results of measurements of the physical structure, including the crystal density, crystal dimensions, aspect ratio of the crystals, crystallinity, and birefringence. Some of the samples contain low levels of α-crystals (<10%, included in the table). This is taken into account for the calculation of the crystallinity, but for the density, dimensions, and aspect ratio the data for the β-crystals is given.

For yarn 3-1c, the dip simulation cannot be carried out in such a way that the breaking tenacity and modulus are maintained while simultaneously reducing the shrinkage to below 4%. For yarn 3-2, the combined demands of high retained breaking tenacity and modulus and low shrinkage can be fulfilled if the dip simulation is carried out at low temperature (Example 5-4). Yam 4-2b proves sufficiently stable to retain its breaking tenacity and modulus while achieving low values for shrinkage at high dip temperature (Examples 5-7 to 5-10).

### EXAMPLE 6

The drawn yarns of Examples 3-1a, 3-1b, and 4-2a were converted into dipped cords. Four drawn yarns (f36) were assembled and twisted to a single f144 yarn. Two such yarn ends were then twisted on a Lezzeni BRH ring twister in the cord constructions shown in Table D. The twist factor TF was calculated from TF=CT\sqrt{LD/D}, with CT=cord twist (tpm), LD=linear density of the cord (tex), and D=density (kg/m³). The density of the yarns 3-1a and 3-1b was 1,247 kg/m³, yarn 4-2a had a density of 1,256 kg/m³.

The cords were dipped in three stages (drying, stretching, relaxation) on the same equipment as described in Example 5. The dip solution was a standard resorcin-formaldehyde-latex. No other additions for rubber adhesion improvement were used. The drying operation took place at 120° C., with a residence time of 120 sec, at 20 mN/tex. The residence time in the stretching step was 30 sec, the temperature and tension for this step are given in Table 5. The residence time in the relaxation step was 30 sec and the tension was 12.5 mN/tex; the temperatures for this step are given in Table 5.

The applied twist gives a reduction of tenacity and modulus when going from yarn to greige cord. The twist also influences the response of breaking tenacity and modulus during dipping. Slight increases in breaking tenacity and considerable increases in modulus are observed when going from greige cord to dipped cord. The change in modulus differs from the behavior during the dip simulation of untwisted yarns, as described in Example 5. However, in both examples the essence of optimizing the combination of high modulus and low shrinkage is shown. For cord dipping, only Examples 6-3 and 6-4 show combinations of high modulus (TASE-2=80 and 90 mN/tex, respectively) and low shrinkage (HAS 2′-180° C.=1.5%). This fully corresponds to the results for dip simulated yarns in Examples 5-7 to 5-10, which were also based on a yarn with sufficient stability. Yams 4-2a and 4-2b differed slightly only in the applied draw ratio, as can be seen from Table 3.

For all the cords presented in Table 5, very high levels of adhesion were measured in a strap peel test using natural rubber Dunlop 5320. Moreover, the fatigue behavior as measured according to the Fatigue of Tire Cords (Disc Fatigue Test) Draft 6 ASTM Z7459Z proved very satisfactory. These additional factors make polyketone cords excellent materials for the reinforcement of rubber goods, especially tires.

The combined information from Examples 5 and 6 shows that polyketone dipped cords with high breaking tenacity, high modulus, and low shrinkage can be obtained from yarns with sufficient stability. By sufficient stability is meant that the yarn and the cord should contain crystals with high density (>1,285 kg/m³), high crystallinity (>40%), and high overall orientation (Δn>0.0570).

TABLE 2
Spinning

| Example # | 1a | 1b | 1c | 2 |
|---|---|---|---|---|
| Melting point polymer, ° C. | 225 | 225 | 225 | 239 |
| Extruder zone temperatures, ° C. | 248 | 248 | 245 | 265 |
| | 248 | 245 | 245 | 265 |
| | 248 | 245 | 245 | 265 |
| | 248 | 245 | 248 | 263 |
| | 248 | 245 | 248 | 263 |
| Spinbox temperature, ° C. | 250 | 250 | 250 | 265 |
| Length hot tube, cm | 12 | 60 | 50 | 50 |
| Temperature hot tube, ° C. | 200 | 250 | 250 | 265 |
| As-spun yarn count, tex | 242 | 240 | 239 | 236 |

TABLE 3
Drawing

| Example # | 3-1a | 3-1b | 3-1c | 3-2 | 4-2a | 4-2b |
|---|---|---|---|---|---|---|
| As-spun yarn from | 1a | 1b | 1c | 2 | 2 | 2 |
| experiment # | | | | | | |
| Drawing, one- or three-step | one | one | one | one | three | three |
| As-spun yarn count, tex | 968 | 240 | 239 | 236 | 236 | 236 |
| | (4 bundles) | | | | | |
| Drawing temperature | 205 | 205 | 205 | 215 | 208 | 190/212 |
| 1st step, ° C. | | | | | | |
| Draw Ratio 1st step | 7.5 | 8.05 | 8.1 | 7.2 | 7.07 | 6.67 |
| Drawing temperature | — | — | — | — | 230 | 233 |
| 2nd step, ° C. | | | | | | |
| Draw Ratio 1st + 2nd step | — | — | — | — | 7.74 | 7.66 |
| Drawing temperature | — | — | — | — | 236 | 235 |
| 3rd step, ° C. | | | | | | |
| Draw Ratio 1st + 2nd + 3rd | — | — | — | — | 8.03 | 7.82 |
| step | | | | | | |
| Total Draw Ratio | 7.5 | 8.05 | 8.1 | 7.2 | 8.03 | 7.82 |
| Drawn Yarn Count, tex | 128.1 | 29.7 | 29.7 | 33.0 | 29.1 | 30.0 |
| F_{d}, mN | 25,000 | 6,800 | 7,100 | 5,700 | 3,000 | 3,100 |
| DT_{d}, mN/tex | 194 | 228 | 241 | 174 | 102 | 103 |
| DT_{d}, corr (last drawing step), | 182 | 215 | 227 | 159 | 182 | 175 |
| mN/tex | | | | | | |
| Breaking Tenacity, mN/tex | 953 | 1,096 | 1,117 | 1,004 | 1,122 | 1,091 |
| Elongation at Break, % | 11.5 | 10.5 | 10.7 | 12.1 | 10.5 | 11.7 |
| TASE-2, mN/tex | 150 | 196 | 221 | 150 | 165 | 144 |
| HAS-2′-180° C. (5 mN/tex), % | 7.3 | 8.8 | 8.2 | 8.6 | 5.7 | 5.9 |
| Tₘ, ° C. | | | 225 | 245 | | 246 |
| V_{c}, % | | | 39.6 | 42.6 | | 44.3 |
| Δn | | | 0.0599 | 0.0574 | | 0.0578 |
| Crystal density D_{c}, kg/m³ | | | 1279.1 | 1294.8 | | 1293.9 |

TABLE 4
Dip Simulation

| Example # | | 5-1 | 5-2 | 5-3 | | 5-4 | 5-5 | 5-6 | | 5-7 | 5-8 | 5-9 | 5-10 |
|---|---|---|---|---|---|---|---|---|---|---|---|---|---|
| Untreated yarn | 3-1c | 3-1c | 3-1c | 3-1c | 3-2 | 3-2 | 3-2 | 3-2 | 4-2b | 4-2b | 4-2b | 4-2b | 4-2b |
| # | | | | | | | | | | | | | |

Dip simulation conditions

| | | | | | | | | | | | | | |
|---|---|---|---|---|---|---|---|---|---|---|---|---|---|
| Temperature | — | 180 | 200 | 220 | — | 200 | 220 | 230 | — | 200 | 230 | 230 | 240 |
| stretching step, | | | | | | | | | | | | | |
| ° C. | | | | | | | | | | | | | |
| Tension in | — | 70 | 70 | 70 | — | 70 | 100 | 70 | — | 70 | 70 | 100 | 70 |
| stretching step | | | | | | | | | | | | | |
| Temperature in | — | 180 | 180 | 180 | — | 200 | 220 | 220 | — | 200 | 220 | 220 | 220 |
| relaxation step, | | | | | | | | | | | | | |
| ° C. | | | | | | | | | | | | | |

Properties

| | | | | | | | | | | | | | |
|---|---|---|---|---|---|---|---|---|---|---|---|---|---|
| Breaking | 1117 | 1017 | 850 | 769 | 1004 | 1036 | 1019 | 1030 | 1091 | 1116 | 1112 | 1105 | 1100 |
| tenacity, | | | | | | | | | | | | | |
| mN/tex | | | | | | | | | | | | | |
| Breaking | — | 91 | 76 | 69 | — | 103 | 102 | 103 | — | 102 | 102 | 101 | 101 |
| tenacity, % | | | | | | | | | | | | | |
| Elongation at | 10.7 | 10.6 | 11.7 | 13.4 | 12.1 | 13.2 | 13.1 | 13.4 | 11.7 | 11.9 | 12.3 | 11.4 | 11.8 |
| break, % | | | | | | | | | | | | | |
| TASE-2, | 221 | 183 | 124 | 82 | 150 | 135 | 128 | 124 | 144 | 165 | 150 | 168 | 157 |
| mN/tex | | | | | | | | | | | | | |
| TASE-2, % | — | 83 | 56 | 37 | — | 90 | 85 | 83 | — | 114 | 104 | 116 | 109 |
| HAS-2′-180° | 8.2 | 4.3 | 1.7 | 1.8 | 8.6 | 3.3 | 2.2 | 2.2 | 5.9 | 2.9 | 2.3 | 2.0 | 2.1 |
| C. (5 mN/tex), | | | | | | | | | | | | | |
| % | | | | | | | | | | | | | |

Physical structure data

| | | | | | | | | | | | | | |
|---|---|---|---|---|---|---|---|---|---|---|---|---|---|
| Crystal density | 1279.1 | 1278.1 | 1279.1 | 1278.2 | 1294.8 | 1294.4 | 1293.8 | 1295.6 | 1293.9 | 1297.8 | 1297.5 | 1291.0 | 1296.6 |
| (β), kg/m³ | | | | | | | | | | | | | |
| L₀₀₂ (β), Å | 219 | 213 | 188 | 151 | 194 | 183 | 195 | 186 | 201 | 208 | 206 | 223 | 205 |
| L₂₁₀ (β), Å | 70 | 78 | 84 | 101 | 73 | 89 | 94 | 94 | 83 | 91 | 93 | 92 | 95 |
| L₃₁₀ (β), Å | 64 | 77 | 81 | 87 | 62 | 72 | 74 | 76 | 66 | 77 | 76 | 74 | 78 |
| Aspect ratio | 3.27 | 2.75 | 2.28 | 1.61 | 2.87 | 2.28 | 2.32 | 2.19 | 2.70 | 2.47 | 2.43 | 2.68 | 2.37 |
| (β) | | | | | | | | | | | | | |
| Crystal size | 9.8 | 12.8 | 12.7 | 13.3 | 8.7 | 11.7 | 13.6 | 13.2 | 11.1 | 14.4 | 14.6 | 15.2 | 15.1 |
| (β), *10⁵ Å³ | | | | | | | | | | | | | |
| α-content, % | 0 | 0 | 0 | 0 | 0 | 6.8 | 6.2 | 9.9 | 7.5 | 3.7 | 5.6 | 7.3 | 7.7 |
| V_{c}, % | 39.6 | 44.7 | 44.1 | 46.8 | 42.6 | 42.3 | 46.5 | 41.7 | 44.3 | 43.8 | 44.4 | 48.6 | 45.0 |
| Δn | 0.0599 | 0.0585 | 0.0574 | 0.0546 | 0.0574 | 0.0572 | 0.0573 | 0.0572 | 0.0578 | 0.0585 | 0.0580 | 0.0584 | 0.0586 |

TABLE 5
Cord Properties

| Example # | 6-1 | 6-2 | 6-3 | 6-4 |
|---|---|---|---|---|
| Drawn yarn # | 3-1a | 3-1b | 4-2a | |
| Yarn | | | | |
| Breaking Tenacity, BT, mN/tex | 953 | 1,096 | 1,122 | |
| Elongation at Break, EAB, % | 11.5 | 10.5 | 10.5 | |
| Modulus, TASE-2, mN/tex | 150 | 196 | 165 | |
| Shrinkage, HAS-2′-180° C. (5 mN/tex), % | 7.3 | 8.8 | 5.7 | |
| Greige cord | | | | |
| Construction, tex, tpm | 2 × 128.1 | 2 × 118.7 | 2 × 115.3 | |
| | 1Z400 × 2S400 | 1Z385 × 2S385 | 1Z385 × 2S385 | |
| Linear Density cord, LD, tex | 280.6 | 258.2 | 248.4 | |
| Twist Factor, TF | 190 | 175 | 171 | |
| BT, mN/tex | 676 | 810 | 829 | |
| BT, % of yarn value | 71 | 74 | 74 | |
| EAB, % | 15.1 | 14.0 | 13.5 | |
| TASE-2, mN/tex | 56 | 73 | 69 | |
| TASE-2, % of yarn value | 37 | 37 | 42 | |
| Dipped cord | | | | |
| Temperature in drawing step, ° C. | 200 | 220 | 220 | 230 |
| Tension in drawing step, mN/tex | 64 | 64 | 70 | 70 |
| Temperature in relaxation step, ° C. | 180 | 180 | 200 | 200 |
| BT, mN/tex | 713 | 809 | 886 | 892 |
| BT, % of value for greige cord | 105 | 100 | 107 | 108 |
| EAB, % | 13.9 | 12.9 | 14.6 | 13.8 |
| TASE-2, mN/tex | 76 | 108 | 80 | 90 |
| TASE-2, % of value for greige cord | 136 | 148 | 116 | 130 |
| HAS-2′-180° C. (5 mN/tex), % | 3.9 | 3.5 | 1.5 | 1.5 |

What is claimed is:

1. Dipped cord made of melt spun filament yarns of a copolymer of alkenes and carbon monoxide having a cord twist factor in the range of 120 to 250 and a
breaking tenacity BT≧750 mN/tex,
TASE-2>70 mN/tex, and
HAS-2′-180° C. (5 mN/tex)<3.6%.

2. Dipped cord according to claim 1, wherein the dipped cord has a
breaking tenacity BT≧800 mN/tex,
TASE-2>75 mN/tex, and
HAS-2′-180° C. (5 mN/tex)<3%.

3. Dipped cord according to claim 2, wherein the melt spun filament yarn after dipsimulation has the following structural properties:
crystal density D_{c}>1,285 kg/m³,
birefringence Δn>0.0570,
crystallinity V_{c}>40%, with an
aspect ratio of crystals 2Λ₀₀₂/(Λ₂₁₀+Λ₃₁₀) between 2 and 3.

4. Dipped cord according to claim 2, wherein the dipped cord has a breaking tenacity BT≧850 mN/tex, and
TASE-2>75 mN/tex.

5. Dipped cord according to claim 4, wherein the melt spun filament yarn after dipsimulation has an aspect ratio of the crystals 2Λ₀₀₂/(Λ₂₁₀+Λ₃₁₀) varying between 2.3 and 2.7.

6. Dipped cord according to claim 1, wherein the copolymer is made up of ethylene/propylene and carbon monoxide, with an amount of propylene of from 0.5 to 4 mole percent of an amount of ethylene.

7. A process for manufacturing the dipped cord according to claim 1, comprising
forming a cord from melt spun filament yarns comprised of a thermoplastic copolymer of alkenes and carbon monoxide having a breaking tenacity BT≧900 mN/tex, a melting point Tₘ>220° C., a crystallinity V_{c}>33%, and a birefringence Δn>0.0550,
dipping the cord in an aqueous solution of resorcinol-formaldehyde-latex (RFL),
drying the dipped cord, and
subsequently subjecting the dried cord to a thermal treatment at a temperature in the range of from 210 to 250° C. under a tension of from 20 to 120 mN/tex.

8. A process for manufacturing the dipped cord according to claim 2, comprising
forming a cord from melt spun filament yarns comprised of a thermoplastic copolymer of alkenes and carbon monoxide having a breaking tenacity BT≧950 mN/tex, a crystal density D_{c}>1,285 kg/m³, a crystallinity V_{c}>40%, and a birefringence Δn>0.0570,
dipping the cord in an aqueous solution of resorcinol-formaldehyde-latex (RFL),
drying the dipped cord, and
subsequently subjecting the dried cord to a thermal treatment at a temperature in the range of from 210 to 250° C. under a tension of from 20 to 120 mN/tex.

9. A rubber article containing the dipped cord according to claim 1.

10. A rubber article containing a dipped cord made by the process of claim 7.

11. A tire containing the dipped cord according to claim 1.

12. A tire containing a dipped cord made by the process of claim 7.
